(19) United States
(12) Patent Application Publication
(10) Pub. No.: US 2018/0164745 A1
(43) Pub. Date: Jun. 14, 2018

(54) TIMEPIECE MOVEMENT AND MECHANICAL TIMEPIECE

(71) Applicant: Seiko Epson Corporation, Tokyo (JP)

(72) Inventor: Masashi TAKANO, Shiojiri (JP)

(21) Appl. No.: 15/839,128

(22) Filed: Dec. 12, 2017

(30) Foreign Application Priority Data
Dec. 13, 2016 (JP) 2016-241142

(51) Int. Cl. G04B 13/02; G04B 27/02; G04B 29/02; G04B 29/04

(52) U.S. Cl. CPC G04B 13/026; G04B 27/026; G04B 15/14; G04B 29/04; G04B 29/022

(57) ABSTRACT

Provided is a timepiece movement that can improve the freedom of design in the layout of a small seconds hand. The timepiece movement has a barrel complete; a wheel train including multiple wheels that turn in conjunction with the barrel complete; an escape wheel that turns in conjunction with the barrel complete; and a small seconds wheel that turns in conjunction with the escape wheel and has a small seconds hand attached thereto. The escape wheel includes a first pinion that mates with a wheel of the wheel train, and a second pinion that mates with the toothed part of the small seconds wheel.

### BACKGROUND

### 1. Technical Field

The present invention relates to a timepiece movement and a mechanical timepiece.

### 2. Related Art

A mechanical timepiece generally has a barrel complete, center wheel, third wheel, and fourth wheel, and an escapement and regulator for controlling the speed of these. Some mechanical timepieces also have a small seconds wheel to which a small seconds hand is attached. See, for example, JP-A-2014-112101.

In timepieces such as described in JP-A-2014-112101, the pinion of the fourth wheel engages the third wheel, and the fourth wheel turns in conjunction with the third wheel. The pinion of the small seconds hand also engages the teeth of the third wheel, and the small seconds hand turns in conjunction with the third wheel.

In such a timepiece, however, the pivot of the small seconds hand can only be disposed to a position where the distance from the pivot of the third wheel to the pivot of the small seconds hand is equal to the distance from the pivot of the third wheel to the pivot of the fourth wheel. This limits where the small seconds hand can be located and therefore the freedom of design.

### SUMMARY

A timepiece movement and a mechanical timepiece according to the invention provide greater freedom locating the small seconds hand and designing the timepiece face.

A timepiece movement according to the invention includes a barrel wheel; a wheel train including multiple wheels that turn in conjunction with the barrel wheel; an escape wheel that turns in conjunction with the wheel train; and a small seconds wheel that turns in conjunction with the escape wheel and has a small seconds hand attached thereto; the escape wheel including a first pinion that engages a wheel of the wheel train, and a second pinion that engages a gear of the small seconds wheel.

This configuration enables setting the pitch diameter of the small seconds wheel to the desired size by configuring the second pinion with the desired number of teeth in the range where the ratio between the number of teeth on the second pinion and the number of teeth of the small seconds wheel is equal to the ratio between the number of teeth on the first pinion and the number of teeth on the gear of the wheel train that mates with the first pinion. As a result, the pivot of the small seconds wheel can be positioned as desired in relation to the pivot of the escape wheel. The location of the small seconds hand can therefore determined with greater freedom than when the pivot of the small seconds wheel must be positioned a specific distance from the pivot of the gear the small seconds wheel engages.

Preferably in a timepiece movement according to another aspect of the invention, the first pinion and the second pinion are discrete.

This configuration makes manufacturing the first pinion and second pinion easier than when the first pinion and second pinion are formed in unison.

Preferably in a timepiece movement according to another aspect of the invention, the first pinion and the second pinion are formed in unison.

Because the pivot of the escape wheel, the first pinion, and second pinion are formed in unison, this configuration simplifies the process of assembling the escape wheel and pinion compared with a configuration in which, for example, the first pinion and second pinion are discrete, and the second pinion is attached to the pivot of the escape wheel to which the first pinion is disposed.

Preferably in a timepiece movement according to another aspect of the invention, the number of teeth on the first pinion and the number of teeth on the second pinion are different.

This configuration enables setting the number of teeth on the second pinion as desired in the range where the ratio between the number of teeth on the second pinion and the number of teeth on the small seconds wheel is equal to the ratio between the number of teeth on the first pinion and the number of teeth on the gear in the wheel train that the first pinion engages. As a result, the pitch diameter of the small seconds wheel can be set to the desired size, and the pivot of the small seconds wheel can be positioned as desired in relation to the pivot of the escape wheel.

Preferably in a timepiece movement according to another aspect of the invention, the number of teeth on the second pinion is greater than the number of teeth on the first pinion.

In this configuration, the pitch diameter of the small seconds wheel is greater than the pitch diameter of the gear in the wheel train the first pinion engages. As a result, the distance from the pivot of the escape wheel to the pivot of the small seconds wheel can be made greater than the distance from the pivot of said gear in the wheel train to the pivot of the escape wheel.

Preferably in a timepiece movement according to another aspect of the invention, in plan view, the pivot of the escape wheel is located between the pivot of the wheel of the wheel train that mates with the first pinion, and the pivot of the small seconds wheel.

More specifically, in plan view, in this aspect of the invention the pivot of the gear the first pinion engages in the wheel train, the pivot of the escape wheel, and the pivot of the small seconds wheel are aligned on the same line.

Aesthetically, the pivot of the small seconds hand is preferably disposed to a position as far as possible from the center of the dial. However, the pitch diameter of the small seconds wheel must be sized at least so that the small seconds wheel does not interfere with other parts.

Compared with a configuration in which, in plan view, the pivot of the gear the first pinion engages in the wheel train, the pivot of the escape wheel, and the pivot of the small seconds wheel are not disposed in line with each other. That is, assuming the pitch diameter of the small seconds wheel is constant, when the pivot of the gear the first pinion engages in the wheel train is in the center of the dial, the pivot of the small seconds wheel can be disposed to a position farther from the center of the dial.

A mechanical timepiece according to another aspect of the invention includes the timepiece movement of the invention, and a small seconds hand disposed to the small seconds wheel.

As with the timepiece movement described above, this configuration improves the freedom of design positioning a small seconds hand.

Further preferably in a mechanical timepiece according to another aspect of the invention, the pivot of the small seconds wheel is offset toward 6:00 from the plane center of the dial.

This aspect of the invention can also be used with timepiece designs having the small seconds hand offset toward 6:00 from the center of the dial.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view of a timepiece according to a preferred embodiment of the invention.

FIG. 2 is a plan view of the movement in this embodiment.

FIG. 3 is a plan view of main parts of the movement in this embodiment.

FIG. 4 is a section view of main parts of the movement in this embodiment.

### DESCRIPTION OF EMBODIMENTS

A preferred embodiment of the present invention is described below with reference to the accompanying figures.

Timepiece Configuration

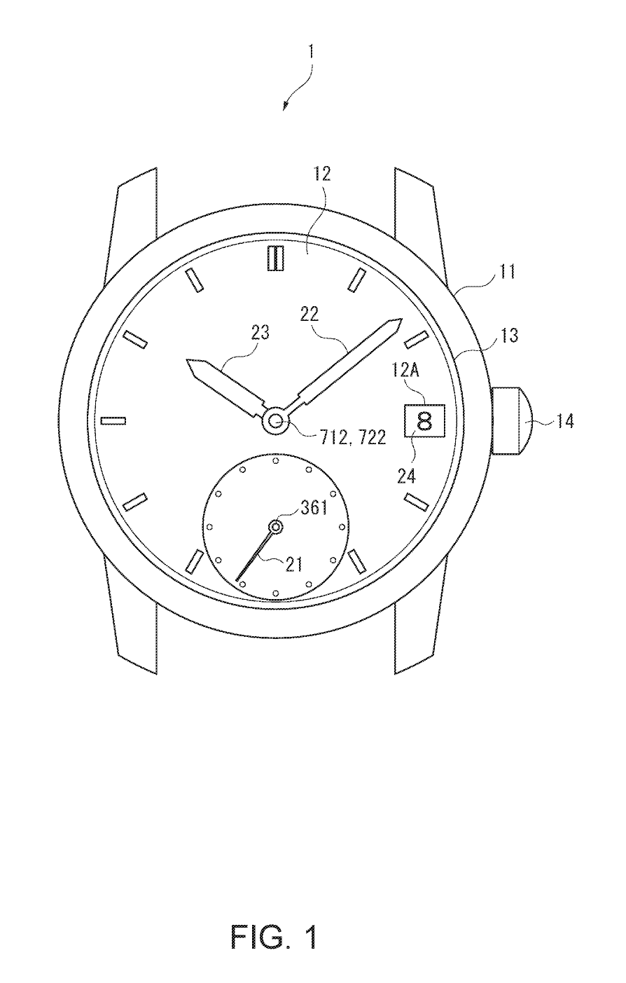

FIG. 1 is a plan view of a timepiece 1 according to a preferred embodiment of the invention.

The timepiece 1 has a cylindrical case 11, and a round dial 12 on the inside circumference side of the case 11. Of the two openings in the case 11, the opening on the front (face) side is covered by a crystal 13, and the opening on the back is covered by a back cover not shown.

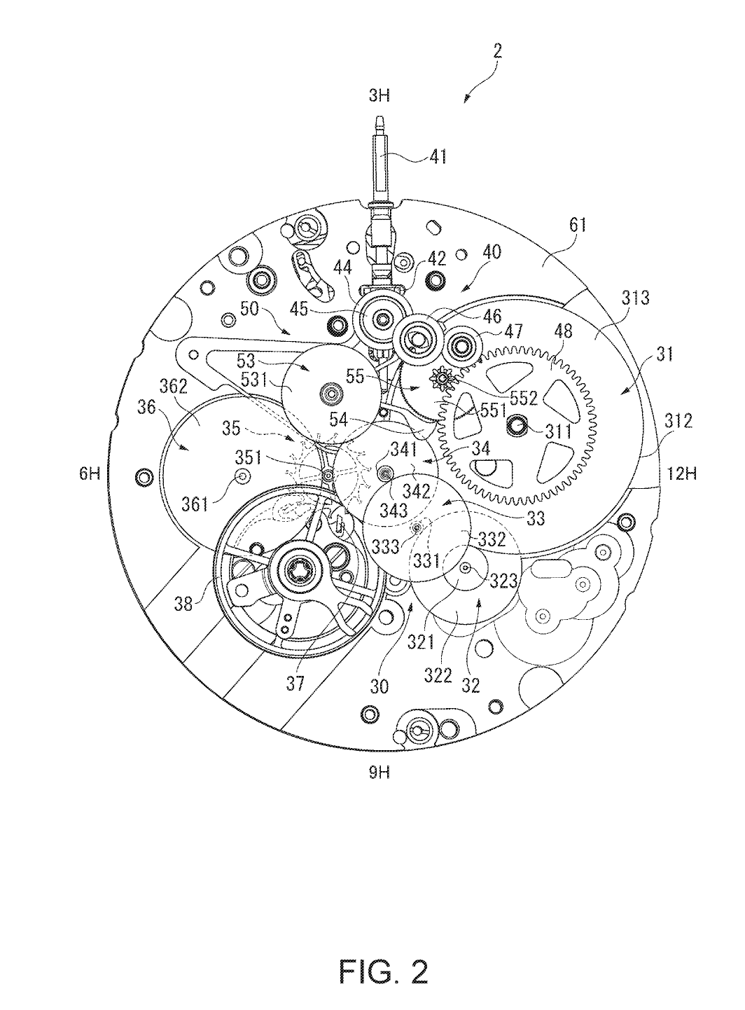

The timepiece movement (FIG. 2) housed inside the case 11 includes a small seconds hand 21, minute hand 22, hour hand 23, and date indicator 24.

The hands 21-23 are disposed on the face side of the dial 12, and the movement 2 is disposed on the back cover side of the dial 12. The hands 21-23 are attached to pivots 361, 712, 722 of the movement 2, and are driven by the movement 2. The minute hand 22 and hour hand 23 are disposed to pivots 712, 722 disposed in the plane center of the dial 12, and the small seconds hand 21 is disposed to a pivot 361 offset toward 6:00 from the plane center of the dial 12.

A date window 12A is also formed in the dial 12, and numbers on the date indicator 24 can be seen through the date window 12A. The numbers on the date indicator 24 in this example indicate the day of the current date (year-month-day).

A crown 14 is disposed in the side of the case 11. The crown 14 can be operated in various ways to input to the timepiece.

Configuration of the Movement

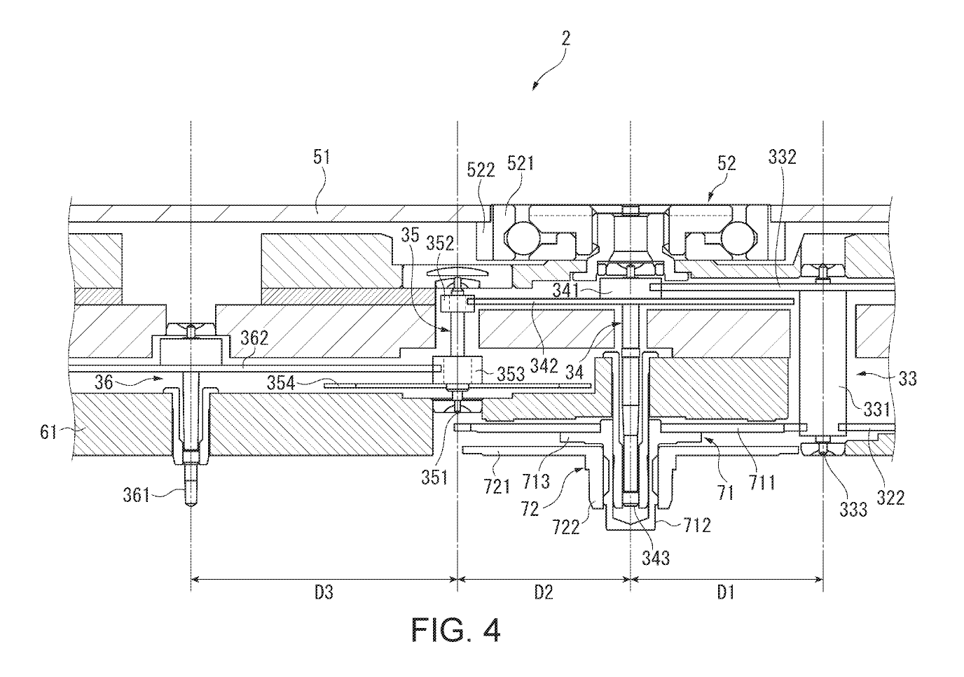

FIG. 2 is a plan view of the movement 2 of the timepiece 1 from the back cover side. In FIG. 2, the 3:00 position of the movement 2 is at the top, 9:00 is at the bottom, 12:00 is on the right side, and 6:00 is on the left side. The wheel train bridge, rotor 51 (see FIG. 4), bearing 52 (see FIG. 4), and other parts are omitted in FIG. 2.

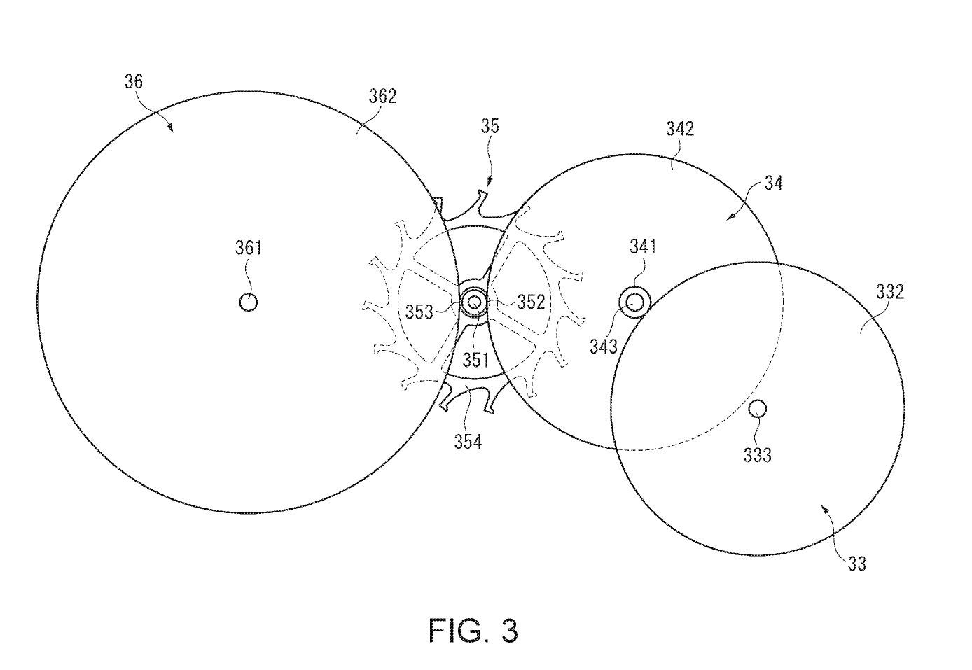

FIG. 3 is a plan view of main parts of the movement 2. FIG. 4 is a section view of main parts of the movement 2. In FIG. 4, the top is the back cover side, and the bottom is the dial 12 side of the movement 2.

As shown in FIG. 2, the movement 2 includes a main wheel train 30, small seconds wheel 36, pallet fork 37, balance 38, manual winding mechanism 40, and automatic winding mechanism 50.

Main Wheel Train

As shown in FIG. 2, the main wheel train 30 includes, disposed to the back cover side of the main plate 61, a barrel complete 31, center wheel and pinion 32, third wheel and pinion 33, fourth wheel and pinion 34, escape wheel and pinion 35, pallet fork 37, and balance 38. The escape wheel and pinion 35 and pallet fork 37 embody the escapement, and the balance 38 embodies the regulator.

Barrel Complete

The barrel complete 31 includes a barrel arbor 311 disposed offset toward 1:00 from the plane center of the dial 12 in plan view, a barrel wheel 312, a barrel cover 313, and a mainspring not shown housed in the space between the barrel wheel 312 and barrel cover 313. The spring is wound by the barrel arbor 311 being turned by the manual winding mechanism 40 or automatic winding mechanism 50 described below. The barrel wheel 312 turns on the barrel arbor 311 as the wound spring unwinds.

Center Wheel and Pinion

The center wheel and pinion 32 is disposed with its pivot 323 offset in plan view toward 10:00 from the center of the dial 12. The center wheel and pinion 32 includes a center pinion 321 that meshes with the barrel wheel 312, and a center wheel 322, and rotates in conjunction with the barrel wheel 312. The pivot 323 and center pinion 321 are formed in unison.

Third Wheel and Pinion

The third wheel and pinion 33 is disposed with the pivot 333 offset in plan view toward 10:00 from the center of the dial 12. The pivot 333 of the third wheel and pinion 33 is offset toward the center of the dial 12 from the pivot 323 of the center wheel and pinion 32. The third wheel and pinion 33 includes a third pinion 331 that meshes with the center wheel 322, and a third wheel 332, and turns in conjunction with the center wheel and pinion 32. The pivot 333 and third pinion 331 are formed in unison.

In this embodiment of the invention the module of the third wheel 332 is 0.1014 mm, and the number of teeth is 60.

Module is the unit of size indicating the size of a gear, and is equal to the pitch diameter divided by the number of teeth. The greater the value, the larger the gear.

The pitch circle is an imaginary circle centered on the center of the gear and passing through the intersection (pitch point) of the common tangent (the line of action) of the base circles of two mating gears, and the line of centers passing through the centers of the two gears. The diameter of this pitch circle is the pitch diameter.

Fourth Wheel and Pinion

The fourth wheel and pinion 34 is disposed with the pivot 343 in the center of the dial 12 in plan view. As shown in FIG. 2 to FIG. 4, the fourth wheel and pinion 34 includes a fourth pinion 341 that meshes with the third wheel 332, and a fourth wheel 342, and turns in conjunction with the third wheel and pinion 33. The pivot 343 and fourth pinion 341 are formed in unison.

In this embodiment of the invention, the module of the fourth pinion 341 is the same 0.1014 mm as the third wheel 332, and the number of teeth is 9. The distance D1 (see FIG. 4) between the pivot 333 of the third wheel and pinion 33 and the pivot 343 of the fourth wheel and pinion 34 is 3.50 mm.

The module of the fourth wheel 342 is 0.0606 mm, and the number of teeth is 96.

The center wheel and pinion 32, third wheel and pinion 33, and fourth wheel and pinion 34 in this embodiment of the invention embody a wheel train that turns in conjunction with the barrel complete 31.

On the dial 12 side of the main plate 61 are disposed a minute wheel and pinion 71 and hour wheel and pinion 72 on pivots 712, 722 in the center of the dial 12 in plan view, and a minute wheel not shown.

The minute wheel and pinion 71 includes the pivot 712, minute wheel 711, and minute pinion 713 formed in unison with the pivot 712. The minute wheel 711 meshes with the third pinion 331, and the minute wheel and pinion 71 turns in conjunction with the third wheel and pinion 33. The teeth of the minute wheel not shown mesh with the minute pinion 713, and the minute wheel not shown turns in conjunction with the minute wheel and pinion 71.

The hour wheel and pinion 72 includes the pivot 722, and an hour wheel 721 formed in unison with the pivot 722. The hour wheel 721 meshes with the pinion of the minute wheel not shown, and the hour wheel and pinion 72 turns in conjunction with the minute wheel not shown.

Note that the minute hand 22 is attached to the pivot 712 of the minute wheel and pinion 71, and the hour hand 23 is attached to the pivot 722 of the hour wheel and pinion 72.

Escape Wheel

The escape wheel and pinion 35 includes a pivot 351 offset toward 6:00 from the center of the dial 12 in plan view, a first escape pinion 352 (see FIG. 3, FIG. 4) as a first pinion, a second escape pinion 353 (see FIG. 3, FIG. 4) as a second pinion, and an escape wheel 354. The pivot 351 and first escape pinion 352 are formed in unison. The second escape pinion 353 is discrete from the first escape pinion 352, and is disposed on the dial 12 side of the first escape pinion 352 with a specific gap therebetween. More specifically, the first escape pinion 352 and second escape pinion 353 are discrete parts. The escape wheel 354 is also discrete from the first escape pinion 352 and second escape pinion 353, and is disposed on the dial 12 side of the second escape pinion 353. Note that the escape wheel and pinion 35 is assembled by attaching the second escape pinion 353 and the escape wheel 354 to the pivot 351 of the first escape pinion 352.

The first escape pinion 352 meshes with the fourth wheel 342, and the escape wheel and pinion 35 turns in conjunction with the fourth wheel and pinion 34.

In this embodiment of the invention the module of the first escape pinion 352 is the same 0.0606 mm as the fourth wheel 342, and the number of teeth is 8. The distance D2 (FIG. 4) between the pivot 343 of the fourth wheel and pinion 34 and the pivot 351 of the escape wheel and pinion 35 is 3.15 mm.

In the example shown in FIG. 2 to FIG. 4, the second escape pinion 353 has more teeth and the pitch diameter is larger than the first escape pinion 352. The module of the second escape pinion 353 is 0.0746 mm and the number of teeth is 10.

Pallet Fork and Balance

As shown in FIG. 2, the pallet fork 37 has two pallets that engage the escape wheel 354, advance the escape wheel 354 according to the reciprocating rotation of the balance 38, and control the speed of the escape wheel and pinion 35. As a result, the speed of the barrel complete 31, center wheel and pinion 32, third wheel and pinion 33, fourth wheel and pinion 34, and small seconds wheel 36 are controlled.

Small Seconds Wheel

The small seconds wheel 36 is offset toward 6:00 from the center of the dial 12 in plan view, and has a pivot 361 to which the small seconds hand 21 is attached. The pivot 361 of the small seconds wheel 36 is on the opposite side of the pivot 351 of the escape wheel and pinion 35 as the center of the dial 12. The pivot 361 of the small seconds wheel 36 is located on a line through the center of the dial 12 and the pivot 351 of the escape wheel and pinion 35. In other words, in plan view, the pivot 351 of the escape wheel and pinion 35 is located between the pivot 343 of the fourth wheel and pinion 34 and the pivot 361 of the small seconds wheel 36.

The small seconds wheel 36 has a small seconds gear 362 that engages the second escape pinion 353, and rotates in conjunction with the escape wheel and pinion 35.

In the example shown in FIG. 2 to FIG. 4, the pitch diameter of the small seconds gear 362 is greater than the pitch diameter of the fourth wheel 342. The module of the small seconds gear 362 is the same 0.0746 mm as the second escape pinion 353, and the number of teeth is 120. The distance D3 (FIG. 4) between the pivot 351 of the escape wheel and pinion 35 and the pivot 361 of the small seconds wheel 36 is 4.85 mm.

In the timepiece 1 according to this embodiment, the fourth wheel and pinion 34 turns one revolution in one minute, the escape wheel and pinion 35 turns 12 times in the time the fourth wheel and pinion 34 turns once in one minute, and the small seconds wheel 36 rotates once each time the escape wheel and pinion 35 turns 12 times in one minute.

In the example in FIG. 2 to FIG. 4, the distance D3 from the pivot 351 of the escape wheel and pinion 35 to the pivot 361 of the small seconds wheel 36 is greater than the distance D2 from the pivot 343 of the fourth wheel and pinion 34 to the pivot 351 of the escape wheel and pinion 35, but distance D3 may be set to a desired distance. In other words, distance D3 may be shorter than distance D2 or equal to distance D2.

If distance D3 is shorter than distance D2, the number of teeth in the second escape pinion 353 is less than the number of teeth on the first escape pinion 352, the module of the second escape pinion 353 is less than the module of the first escape pinion 352, and the pitch diameter of the small seconds gear 362 is smaller than the pitch diameter of the fourth wheel 342.

If distance D3 and distance D2 are the same, the number of teeth and module of the second escape pinion 353 are the same as the number of teeth and module of the first escape pinion 352, and the pitch diameter of the small seconds gear 362 are the same as the pitch diameter of the fourth wheel 342.

In other words, the number of teeth of the second escape pinion 353 in this timepiece 1 may be desirably set within the range where the ratio between the number of teeth of the second escape pinion 353 and the number of teeth of the small seconds gear 362 is equal to the ratio between the number of teeth on the first escape pinion 352 and the number of teeth on the fourth wheel 342.

Manual Winding Mechanism

As shown in FIG. 2, the manual winding mechanism 40 includes a winding stem 41, winding pinion 42, sliding pinion not shown, crown wheel 44, intermediate ratchet wheels 45, 46, 47, and ratchet wheel 48.

A square hole is formed through the axis of rotation of the sliding pinion, and the winding stem 41 passes through this hole. As a result, the sliding pinion and winding stem 41 turn together.

A round hole is formed through the axis of rotation of the winding pinion 42, and the winding stem 41 is disposed rotatably in this hole. When the winding stem 41 is at the 0 stop pushed all the way in towards the center of the movement 2, the winding pinion 42 engages the sliding pinion and rotates together with the sliding pinion.

The crown wheel 44 engages the winding pinion 42, and rotates in conjunction with the winding pinion 42. When the crown wheel 44 turns, the intermediate ratchet wheels 45, 46, 47 turn, and the ratchet wheel 48 turns. When the ratchet wheel 48 turns, the barrel arbor 311 rotates in conjunction with the ratchet wheel 48, and the mainspring is wound.

The manual winding mechanism 40 enables the user to wind the mainspring by turning the crown 14.

Automatic Winding Mechanism

The automatic winding mechanism 50 includes the rotor 51 (FIG. 4), bearing 52 (FIG. 4), eccentric wheel 53, pawl lever 54, and transmission wheel 55.

The rotor 51 seen in plan view is a half circle centered on the axis of rotation of the bearing 52. The rotor 51 is attached to the outer race 521 of the bearing 52, and the outer race 521 turns in conjunction with the rotor 51.

The eccentric wheel 53 has an eccentric gear 531 and eccentric pivot. The eccentric gear 531 engages the rotor pinion 522 disposed to the outside circumference of the outer race 521 of the bearing 52, and the eccentric wheel 53 turns in conjunction with the rotor 51.

The pawl lever 54 has a pull-pawl and a push-pawl that catch the transmission wheel 55, and are attached to the eccentric pivot of the eccentric wheel 53. The pawl lever 54 moves reciprocally in toward and away from the transmission wheel 55 in conjunction with rotation of the eccentric wheel 53.

The transmission wheel 55 includes a transmission gear 551 engaged by the pull-pawl and push-pawl of the pawl lever 54, and a transmission pinion 552 that meshes with the ratchet wheel 48. The transmission wheel 55 turns in conjunction with the reciprocating action of the pawl lever 54. The ratchet wheel 48 turns in conjunction with the transmission wheel 55. When the ratchet wheel 48 turns, the barrel arbor 311 turns in unison with the ratchet wheel 48, and the mainspring is wound.

This automatic winding mechanism 50 winds the mainspring by the rocking of the rotor 51 when the timepiece 1 swings back and forth while worn on the user's wrist.

Operating Effect

The pitch diameter of the small seconds gear 362 can be sized as desired in this timepiece 1 insofar as the ratio between the number of teeth of the second escape pinion 353 and the number of teeth of the small seconds gear 362 is equal to the ratio between the number of teeth on the first escape pinion 352 and the number of teeth on the fourth wheel 342. As a result, the pivot 361 of the small seconds wheel 36 can be located at a desired position away from the pivot 351 of the escape wheel and pinion 35. Freedom in the layout of the small seconds hand 21 is therefore greater than when the pivot 361 of the small seconds wheel 36 can only be located at a position within a specific distance from the pivot of the gear the small seconds wheel 36 meshes with. The number of gears therefore does not increase because there is no need to provide an additional transmission gear, for example.

Furthermore, in a configuration in which the pinion of the small seconds wheel 36 engages the third wheel 332, the small seconds wheel 36 must be located so that the pinion of the small seconds wheel 36 does not overlap the fourth wheel 342. In a timepiece 1 according to the invention, however, the small seconds gear 362 engages a second escape pinion 353 at a different axial position than the first escape pinion 352 that meshes with the fourth wheel 342, and the small seconds wheel 36 can therefore be disposed to a position overlapping the fourth wheel and pinion 34.

Furthermore, because the first escape pinion 352 and second escape pinion 353 are discrete, the first escape pinion 352 and second escape pinion 353 can be manufactured more easily than when the first escape pinion 352 and second escape pinion 353 are disposed in unison (not discrete).

Furthermore, when manufacturing a timepiece not having a small seconds hand 21 and having an escape wheel to which a second escape pinion 353 is not disposed, there is no need to manufacture a new escape wheel part because there is no need to attach a second escape pinion 353 to the escape wheel.

Locating the pivot 361 of the small seconds wheel 36 at a position offset as far as possible from the plane center of the dial 12 is desirable in terms of design aesthetics. However, the pitch diameter of the small seconds gear 362 must be sized so that at least the small seconds wheel 36 does not interfere with other parts.

In the timepiece 1 according to the invention, in plan view, the pivot 343 of the fourth wheel and pinion 34, the pivot 351 of the escape wheel and pinion 35, and the pivot 361 of the small seconds wheel 36 are on a single straight line. This affords the following effect in comparison with a configuration in which the pivot 343, pivot 351, and pivot 361 are not on the same line in plan view. That is, assuming the pitch diameter of the pivot 361 is constant, the pivot 361 of the small seconds wheel 36 can be disposed to a position far from the center of the dial 12.

### Other Embodiments

The invention is not limited to the embodiments described above, and can be modified and improved in many ways without departing from the scope of the accompanying claims.

The wheel that engages the first escape pinion 352 of the escape wheel and pinion 35 is the fourth wheel and pinion 34 in the above embodiment, but the invention is not so limited. More specifically, the wheel engaging the first escape pinion 352 may be any wheel that turns in unison with the barrel complete 31, and can drive the escape wheel and pinion 35 at a specific speed.

In the foregoing embodiment, when the distance D3 between the pivot 351 of the escape wheel and pinion 35 and the pivot 361 of the small seconds wheel 36, and the distance D2 between the pivot 343 of the fourth wheel and pinion 34 and the pivot 351 of the escape wheel and pinion 35, are different, both the number of teeth and module of the second escape pinion 353 are set to different values than the number of teeth and module of the first escape pinion 352, but the invention is not so limited.

More specifically, the number of teeth and module of the second escape pinion 353 may be set to different values than the first escape pinion 352, and the pitch diameter of the small seconds gear 362 may be a different from the pitch diameter of the fourth wheel 342. However, setting both the number of teeth and module to different values enables increasing the difference in the pitch diameters of the small seconds gear 362 and the fourth wheel 342.

In the foregoing embodiment, the first escape pinion 352 and second escape pinion 353 are discrete parts, but the invention is not so limited. More specifically, the first escape pinion 352 and second escape pinion 353 may be disposed in unison. In this case, of the pinions formed in unison, the part that mates with the fourth wheel 342 embodies the first escape pinion 352, and the part that mates with the small seconds gear 362 embodies the second escape pinion 353. If the fourth wheel 342 and small seconds gear 362 are disposed at the same elevation in the axial direction, and the part mating with the fourth wheel 342 and the part mating with the small seconds gear 362 are the same, this same part embodies the first escape pinion 352 and second escape pinion 353.

As a result, because the pivot 351, first escape pinion 352, and second escape pinion 353 can be formed in unison, assembling the escape wheel and pinion 35 is easier than if, for example, the first escape pinion 352 and second escape pinion 353 are discrete parts, and the second escape pinion 353 is attached to the pivot 351 of the pivot 351.

In this embodiment, in plan view, the pivot 361 of the small seconds wheel 36 is on a line through the pivot 343 of the fourth wheel and pinion 34 and the pivot 351 of the escape wheel and pinion 35, but the invention is not so limited. More specifically, in plan view, the pivot 361 of the small seconds wheel 36 may be disposed in any desired direction from the pivot 351 of the escape wheel and pinion 35.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No. 2016-241142, filed Dec. 13, 2016 is expressly incorporated by reference herein.

What is claimed is:

1. A timepiece movement comprising:
a barrel wheel;
a wheel train including multiple wheels that turn in conjunction with the barrel wheel;
an escape wheel that turns in conjunction with the wheel train; and
a small seconds wheel that turns in conjunction with the escape wheel and has a small seconds hand attached thereto;
the escape wheel including a first pinion that engages a wheel of the wheel train, and a second pinion that engages a gear of the small seconds wheel.

2. The timepiece movement described in claim 1, wherein:
the first pinion and the second pinion are discrete parts.

3. The timepiece movement described in claim 1, wherein:
the first pinion and the second pinion are formed in unison.

4. The timepiece movement described in claim 1, wherein:
the number of teeth of the first pinion and the number of teeth of the second pinion are different.

5. The timepiece movement described in claim 1, wherein:
the number of teeth of the second pinion is greater than the number of teeth of the first pinion.

6. The timepiece movement described in claim 1, wherein:
in plan view, the pivot of the escape wheel is located between the pivot of the wheel of the wheel train that mates with the first pinion, and the pivot of the small seconds wheel.

7. The timepiece movement described in claim 1, further comprising:
a small seconds hand attached to the small seconds wheel.

8. The timepiece movement described in claim 7, wherein:
the pivot of the small seconds wheel is located on the 6:00 side of the plane center of the dial.
